(19) United States
(12) Patent Application Publication
(10) Pub. No.: US 2014/0072428 A1
(43) Pub. Date: Mar. 13, 2014

(54) WIND TURBINE SYSTEM WITH INFLATABLE ROTOR ASSEMBLY

(71) Applicant: Technical Products, Inc., Sterling, MA (US)

(72) Inventor: Paul A. Chambers, Harvard, MA (US)

(21) Appl. No.: 14/021,644

(22) Filed: Sep. 9, 2013

Related U.S. Application Data
(60) Provisional application No. 61/697,911, filed on Sep. 7, 2012.

(51) Int. Cl. F03D 1/06

(52) U.S. Cl. CPC F03D 1/06
USPC 416/1; 416/84

(57) ABSTRACT

A wind turbine assembly comprising an inflatable rotor assembly.

### REFERENCE TO PENDING PRIOR PATENT APPLICATION

This patent application claims benefit of pending prior U.S. Provisional Patent Application Ser. No. 61/697,911, filed Sep. 7, 2012 by Paul Chambers for INFLATABLE VERTICAL AXIS WIND TURBINE, which patent application is hereby incorporated herein by reference.

### FIELD OF THE INVENTION

This invention relates to wind turbines in general, and more particularly to wind turbines with inflatable rotor assemblies.

### BACKGROUND OF THE INVENTION

Conventional wind turbines are generally large metal structures mounted on towers which require significant time and effort to erect, significant time and effort to disassemble, occupy a large volume when disassembled, and are heavy and cumbersome to transport. Conventional wind turbines cannot be brought “on line” until the tower is erected, which generally requires substantial resources to be diverted from other activities.

Thus there is a need for a new and improved wind turbine which can be quickly and easily deployed and, ideally, requires minimal manpower and/or external mechanical assistance to do so. There is also a need for a new and improved wind turbine which can be quickly and easily disassembled and, once disassembled, occupies minimal volume, and weighs as little as possible and is easily transported.

### SUMMARY OF THE INVENTION

The present invention provides a new and improved wind turbine system which can be quickly and easily deployed, and which requires minimal manpower and/or external mechanical assistance to do so. The present invention also provides a new and improved wind turbine system which can be quickly and easily disassembled and, once disassembled, occupies minimal volume, and weighs as little as possible and is easily transported.

More particularly, in one preferred form of the present invention, there is provided a new and improved wind turbine system which comprises an inflatable rotor assembly (e.g., a self-erecting, fully-inflatable, vertical axis Savonius rotor assembly) which can be deployed directly out of the top of a shipping container (e.g., a Tricon container) such as is shown in FIGS. 1A, 1B and 1C, or another ISO container, or a box truck or truck trailer or other structure, or can be deployed as a stand-alone device. The new and improved wind turbine system preferably also comprises a generator which is close-coupled to the inflatable rotor assembly, and a battery storage unit (sometimes hereinafter referred to as a battery pack, a battery array, a battery bank, etc.) which is fed by the generator. The new and improved wind turbine system preferably also comprises dc/ac power conversion and control electronics which allow the wind turbine system to operate off-grid or as part of a mini-grid feeding excess power to other users in the mini-grid. In one preferred form of the invention, the inflatable rotor assembly self-deploys out of the top of a Tricon container (or other structure) when the inflatable rotor assembly is inflated. The generator, battery storage unit, dc/ac power conversion and control electronics, as well as an air compressor for inflating the inflatable rotor assembly, are all preferably housed within the Tricon container (or other structure).

Thus, in one form of the present invention, the wind turbine system comprises an inflatable rotor assembly, preferably a self-erecting, fully-inflatable, vertical axis Savonius rotor assembly. This approach offers numerous advantages over conventional wind turbines which utilize a rigid metal rotor assembly, including but not limited to:
the inflatable rotor assembly can self-erect out of the Tricon container (or other structure) upon inflation, preferably in about 5 minutes or so, thereby obviating the need for the time-consuming hand assembly of conventional rotor assemblies, towers, material handling devices, etc.;
when deflated for storage, the inflatable rotor assembly takes up minimal volume;
the inflatable rotor assembly weighs very little (e.g., less than 100 pounds for a 25 foot high, 6 foot diameter rotor) while generating high torque, thus providing very low cut-in speeds (e.g., less than 8 miles per hour);
the inflated rotor assembly is very forgiving of abuse and, in extreme wind conditions, can either be quickly deflated or will bend with the wind and then recover when the wind eases—this is a significant advantage over rigid metal rotor assemblies, which can be permanently damaged by extreme wind conditions; and
the inflated rotor assembly is substantially “invisible” to radar, generating substantially no radar signature for detection by hostile forces and creating substantially no radar “shadow” for masking threats.

In one preferred form of the present invention, there is provided a wind turbine assembly comprising an inflatable rotor assembly.

In another preferred form of the present invention, there is provided a method for producing power, the method comprising:

providing a wind turbine assembly comprising an inflatable rotor assembly;

inflating the inflatable rotor assembly;

allowing moving fluid to contact the inflatable rotor assembly, whereby to rotate the inflatable rotor assembly; and

harnessing the rotational motion of the rotor assembly so as to produce power.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1A-1C are schematic views showing a novel wind turbine system formed in accordance with the present invention, wherein the novel wind turbine system comprises an inflatable rotor assembly;

FIG. 2A is a schematic view showing an exemplary Horizontal Axis Wind Turbine (HAWT);

FIGS. 2B and 2C are schematic views showing exemplary Vertical Axis Wind Turbines (VAWTs);

FIGS. 3A and 3B are schematic views showing various aspects of a Savonius-type VAWT;

FIG. 4 is a schematic view showing the efficiency of various types of wind turbines;

FIG. 4A is a schematic view showing various performance attributes of a Savonius rotor assembly;

FIG. 5 is a schematic view showing the torque coefficient curve for a basic two-bladed Savonius rotor assembly as it rotates under wind load;

FIG. 6A is a schematic view showing various exemplary stepped Savonius rotor assemblies;

FIG. 6B is a schematic view of an exemplary helical Savonius rotor assembly;

FIG. 7A is a schematic view showing the power coefficient-velocity attributes of various Savonius rotor assemblies;

FIG. 7B is a schematic view showing the power coefficient-velocity attributes of various Savonius rotor assemblies;

FIG. 8 is a schematic view showing an air beam of the type which may be utilized in connection with the present invention;

FIGS. 9A and 9B are schematic views showing an inflatable Savonius rotor assembly formed in accordance with the present invention;

FIG. 9C is a schematic view showing an alternative form of inflatable Savonius rotor assembly formed in accordance with the present invention;

FIGS. 10A and 10B are schematic views showing another alternative form of inflatable Savonius rotor assembly formed in accordance with the present invention;

FIG. 11 is a schematic view of an alternative form of air beam which may be utilized in connection with the present invention;

FIG. 12 is a schematic view of an air compressor which may be utilized in connection with the present invention;

FIG. 13 is a schematic view of a generator which may be utilized in connection with the present invention;

FIG. 13A is a schematic view of a battery which may be utilized in connection with the present invention;

FIG. 13B is a schematic view showing power flow in the novel wind turbine system of the present invention;

FIG. 13C is a schematic view showing control electronics which may be utilized in connection with the present invention;

FIG. 13D is a schematic view of an inverter which may be utilized in connection with the present invention;

FIG. 14 is a schematic view of a Tricon container which may be utilized in connection with the present invention;

FIG. 15 is a schematic view showing further details of the novel wind turbine system formed in accordance with the present invention; and

FIG. 16 is a schematic view showing a comparison of the operating parameters of the novel wind turbine system of the present invention vs. a similar, commercially-available wind turbine.

### DETAILED DESCRIPTION OF THE PREFERRED EMBODIMENTS

The present invention provides a new and improved wind turbine system which can be quickly and easily deployed, and which requires minimal manpower and/or external mechanical assistance to do so. The present invention also provides a new and improved wind turbine system which can be quickly and easily disassembled and, once disassembled, occupies minimal volume, and weighs as little as possible and is easily transported.

### Wind Turbines in General

Wind turbines are rotary mechanical devices which extract energy from wind flow and convert it to useful work. Wind turbines generally comprise a rotor assembly which comprises a shaft (or drum) with “blades” attached—moving fluid acts on the blades so that they impart rotational motion to the shaft (or drum).

There are two generic configurations for wind turbines: Horizontal Axis Wind Turbines (HAWTs) and Vertical Axis Wind Turbines (VAWTs).

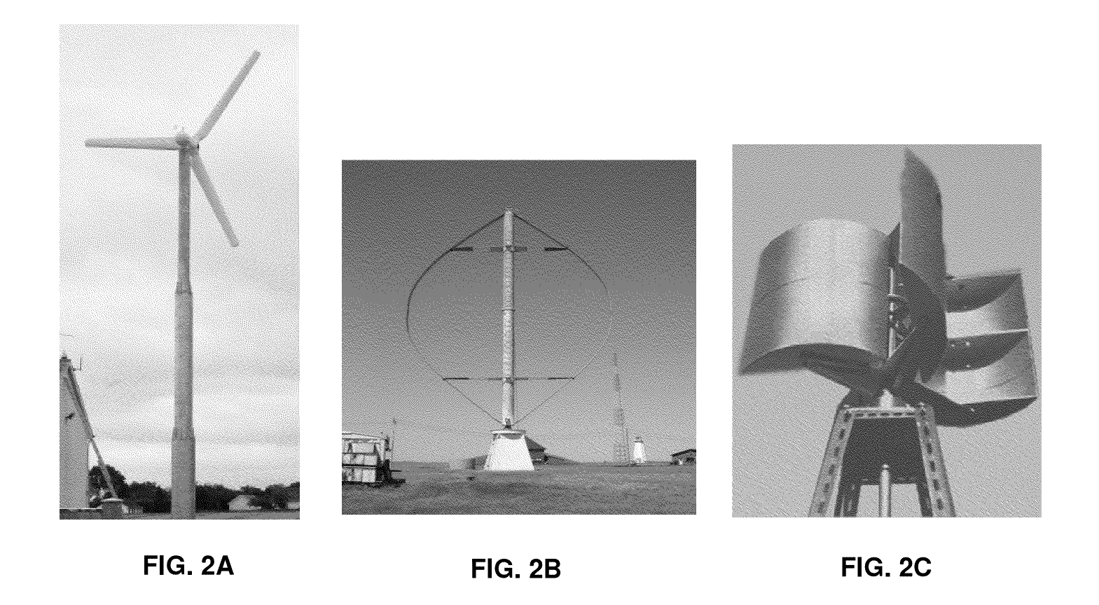

Horizontal axis wind turbines (HAWTs) are the most common type of wind turbine. As seen in FIG. 2A, HAWTs have their turbine body disposed parallel to the ground, with multiple (e.g., 2-6) vertical blades arranged generally like an aircraft propeller. With HAWTs, the turbine and an associated generator are close-coupled, and commonly tower-mounted, to position the turbine blades high up into the wind stream, and they typically require a means to orient the rotor assembly into the wind. And with HAWTs, the rotation speed of the rotor assembly is very high, but the torque is low. For these reasons, HAWTs tend to have complicated structures and difficult installation procedures. In general, HAWTs are best suited to settings with relatively consistent wind direction and relatively high wind speeds.

Vertical Axis Wind Turbines (VAWTs) come in a variety of forms (see, for example, FIGS. 2B and 2C), but all have their main rotor shaft running vertically and they generally are fitted with fewer blades (e.g., 2-4). In VAWTs, the generator is generally mounted at the base of the “mast” (i.e., the rotor shaft) and the blades are wrapped around the rotor shaft, putting most of the system weight low to the ground. VAWTs operate independently of wind direction, and the rotation speed of VAWTs is low compared to HAWTs (and the torque of VAWTs is high compared to HAWTs), hence VAWTs offer a comparatively simple structure and installation procedure. VAWTs offer much higher reliability and lower maintenance than HAWTs, and hence are very attractive for military and emergency relief applications.

The most popular types of VAWTs are the Darrieus wind turbine (FIG. 2B) and the Savonius rotor (FIG. 2C).

The Darrieus wind turbine (FIG. 2B), commonly known as an “Eggbeater”, comprises a rotor assembly that has two vertically-oriented blades revolving around a vertical shaft. The two vertically-oriented blades use aerodynamic lift principles to apply torque to the vertical shaft and rotate the rotor assembly. This is a high-speed, low-torque machine suitable for generating alternating current (AC) electricity. Darrieus turbines generally require a manual “push” to start turning, inasmuch as the starting torque is very low.

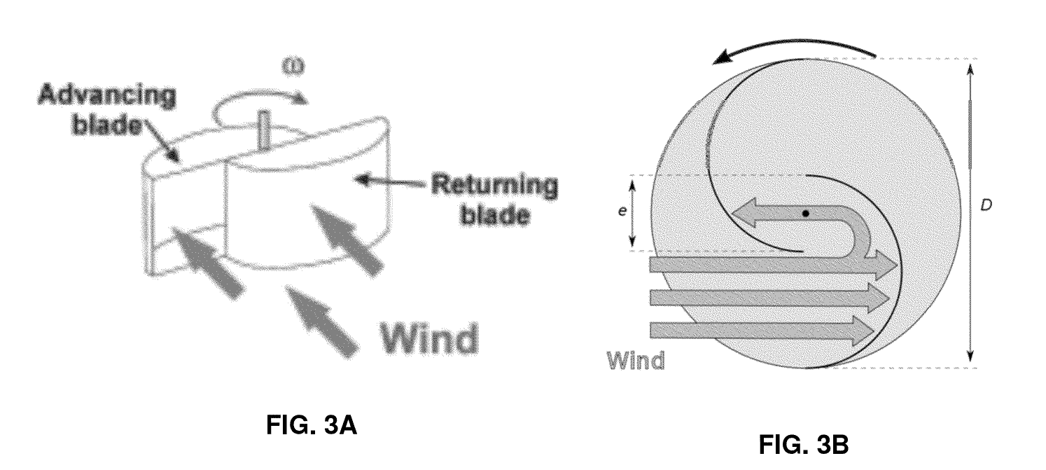

The Savonius wind turbine (FIG. 2C) comprises a rotor assembly that includes two or more half-cylinder-shaped blades. While most wind turbines use lift generated by airfoil-shaped blades to drive the rotor shaft, the Savonius turbine uses the difference between the drag on the concave advancing “paddle” (blade) and the drag on the convex returning “paddle” (blade) and, therefore, cannot rotate faster than the approaching wind speed (FIGS. 3A and 3B). Thus, a Savonius wind turbine is a slow-rotating, high-torque machine and is commonly used in high-reliability, low-efficiency power turbine applications. Savonius turbines offer a number of advantages over HAWTs and other VAWTs, including but not limited to:
simpler and cheaper construction;
acceptance of wind from any direction, thus eliminating the need for re-orientation of the rotor assembly with changing wind direction;
high applied torque at start; and
relatively low operating speeds (rpm), resulting in reduced maintenance requirements.

### Savonius Wind Turbines

The power generated by a wind turbine is a function of the kinetic energy of the moving air. This energy is calculated by the equation:

Pw=½mv2 (Eq. 1)

where m (kg/s) is the air mass flow rate and v (m/s) is the speed of the blowing air.

To derive the power applied to the surface area which is swept by the rotor assembly, we substitute into Eq. 1 to produce:

Pw=½ρv3A (Eq. 2)

where Pw (watt) is power, ρ (kg/m3) is air density and A(πR2) is the surface area which is swept by the rotor assembly.

To calculate the power produced by the wind turbine, we use:

Pt(θ)=F(θ).v(θ)=T(θ)ω(θ) (Eq. 3)

where θ is the angular position of the wind turbine, T is the torque of the force vertical to the turbine blade's surface (force of air pressure), v is the speed vector of the force at point F, and ω is the rotating speed of the turbine blade.

The power factor (Cp) can then be defined as the ratio between the power in the turbine shaft (Pt) and the wind power (Pw) due to its kinetic energy immediately before the turbine plane, which yields:

Cp=Pt/Pw (Eq. 4)

The foregoing relationships support the following deductions:
the power output of a wind generator is proportional to the area swept by the rotor assembly, e.g., doubling the swept area doubles the power output; and
the power output of a wind generator is proportional to the cube of the wind speed, e.g., doubling the wind speed increases the power output by a factor of eight (i.e., 2×2×2=8).

This implies that it is generally better to position the rotor assembly of the wind turbine into an area of high speed wind rather than to increase the size of the rotor assembly. Given the nature of wind speeds, which tend to be lower close to the ground, this generally translates into “the taller the better”.

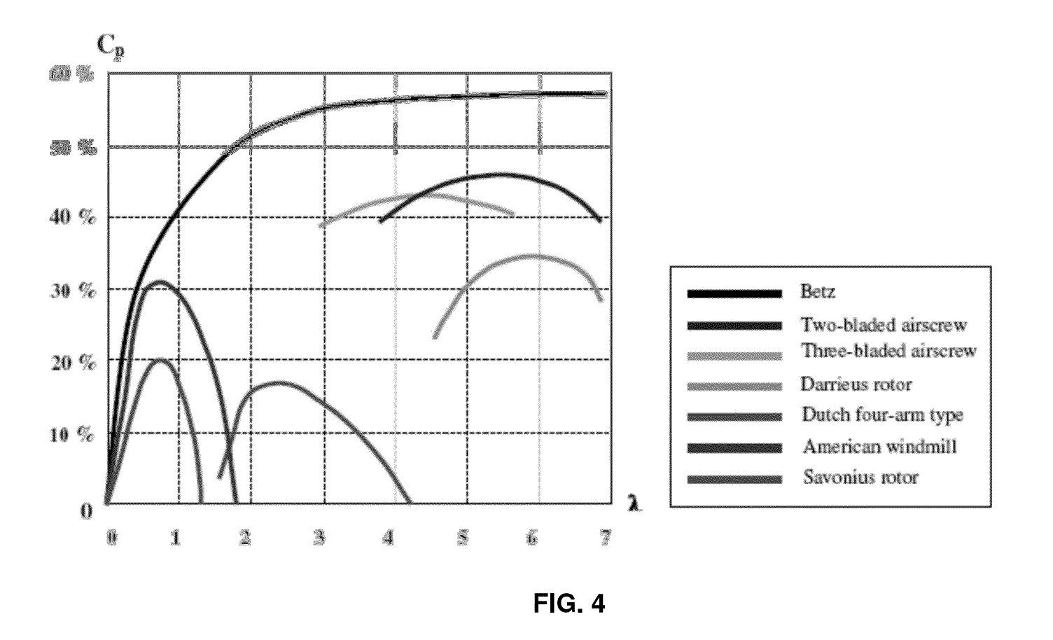

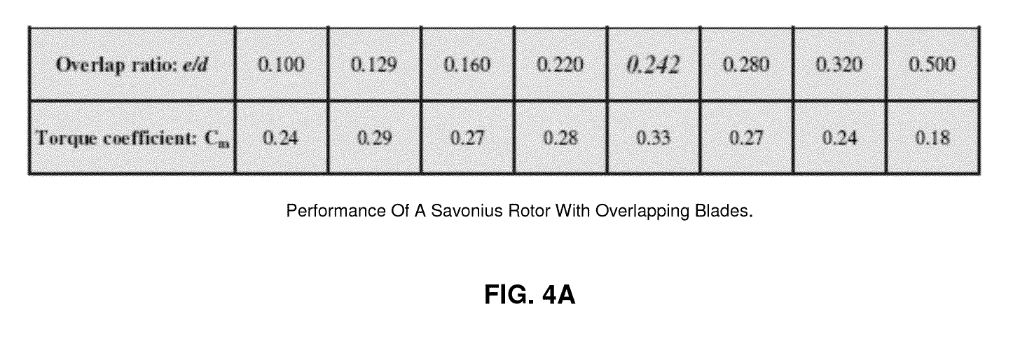

However, the choice of a wind turbine is generally not based solely on its energetic performance. FIG. 4 shows the efficiency of some common wind turbines, by plotting the power coefficient (Cp) versus the ratio of tip speed to wind speed (λ). More particularly, these curves give the power coefficient Cp (the ratio of the aerodynamic power of the wind turbine to the power of the incident wind) as a function the speed ratio λ (also called the velocity coefficient and equal to the ratio of the tip peripheral speed to the wind velocity). The power coefficient is directly proportional to the efficiency of a wind turbine. FIG. 4 shows that the high-velocity horizontal axis wind turbines (e.g., the two-bladed or three-bladed airscrew HAWTs) have the best efficiencies (e.g., on the order of 45%). The basic Savonius rotor VAWT (λ≈1.0) has a lower efficiency of around 20%. The present invention “trades off” this loss of efficiency against the simplicity and robustness of the system in terms of ease of erection/deployment/disassembly, transport, and operation and maintenance.

As noted above, the basic configuration for a Savonius rotor assembly is shown in FIGS. 3A and 3B. The major variables in a Savonius rotor assembly are rotor diameter (D) and blade overlap (e). In the simplest Savonius rotor assembly, blade overlap is zero, resulting in a continuous S-shaped rotor assembly, which produces a Cp of 20% as discussed above. There are, however, modifications to this basic configuration that can significantly increase Cp. More particularly, providing some blade overlap allows impinging air to be diverted onto the “back” blade, increasing the energy input to the rotor assembly as seen in FIG. 3B. There is a limit to the useful overlap, however, as it starts to reduce the baseline blade area exposed to the wind. FIG. 4A shows that an e value of approximately 0.25× the diameter of one of the blades is optimal, and raises the Cp to around 33%—equivalent to the Darrieus rotor and just below the performance of HAWTs.

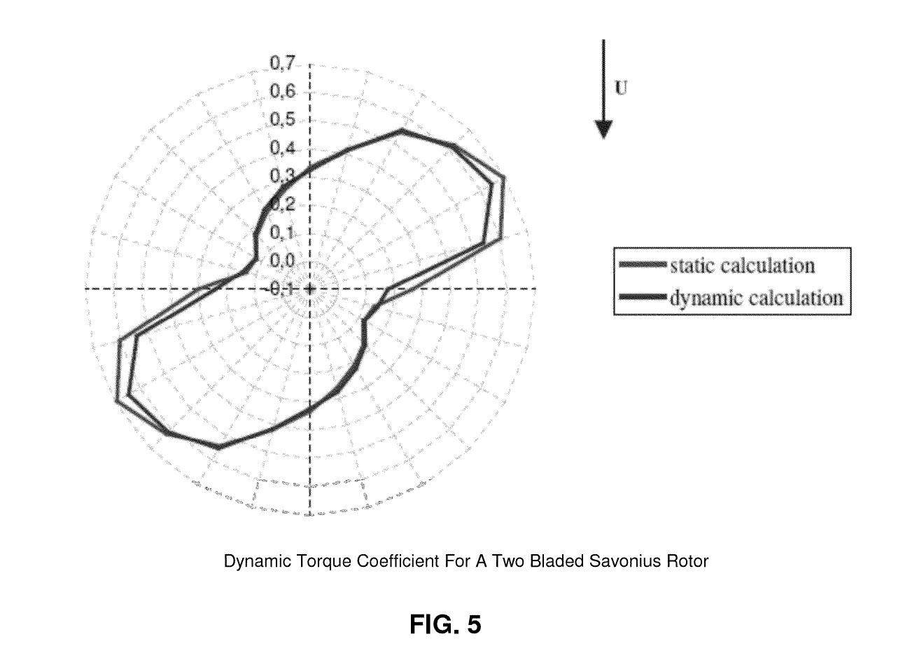

One other simple modification to the baseline Savonius rotor assembly is to address the issue of the rotor torque curve. FIG. 5 shows the torque coefficient curve for a basic Savonius rotor assembly as it rotates under wind load. This bi-lobal shape for the torque coefficient curve is expected from a “two-blades-at −180-degree” design, but it is not optimal for power transfer to an electrical generator. One solution is to have more than two blades, e.g., three blades as shown in FIG. 2C. However, this three-blade configuration makes it extremely difficult to incorporate the optimum blade overlap discussed above. In addition, because the three blades are angled at 120 degrees, some impinging wind tends to be reflected back onto the “following” blade, which exerts a negative force on that trailing blade, thereby reducing the overall efficiency of the system.

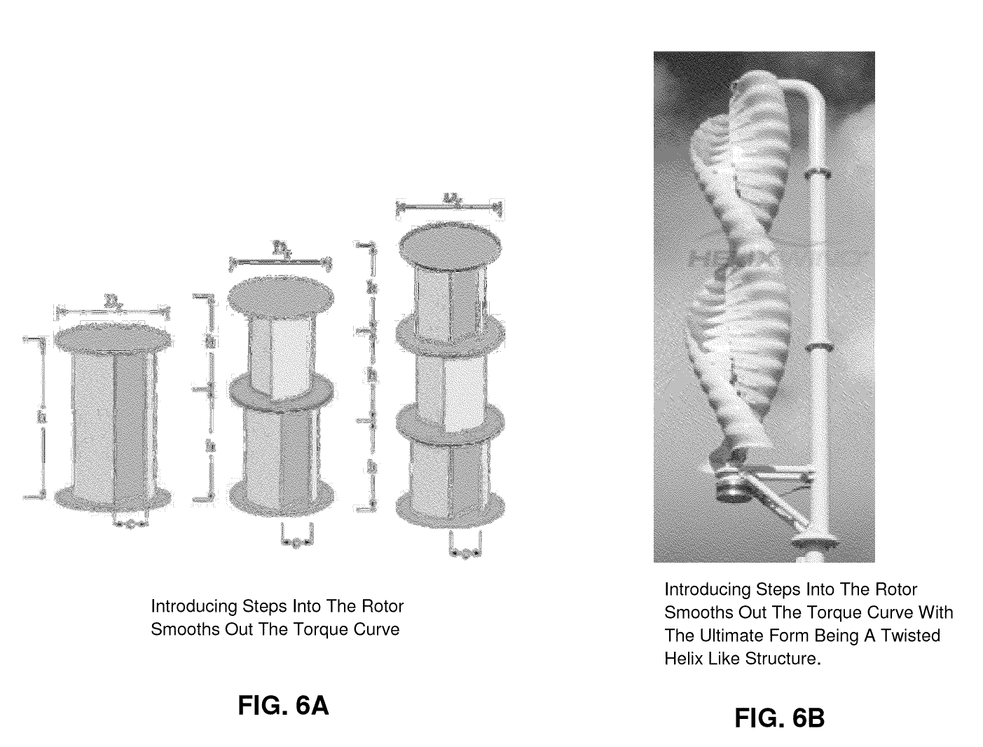

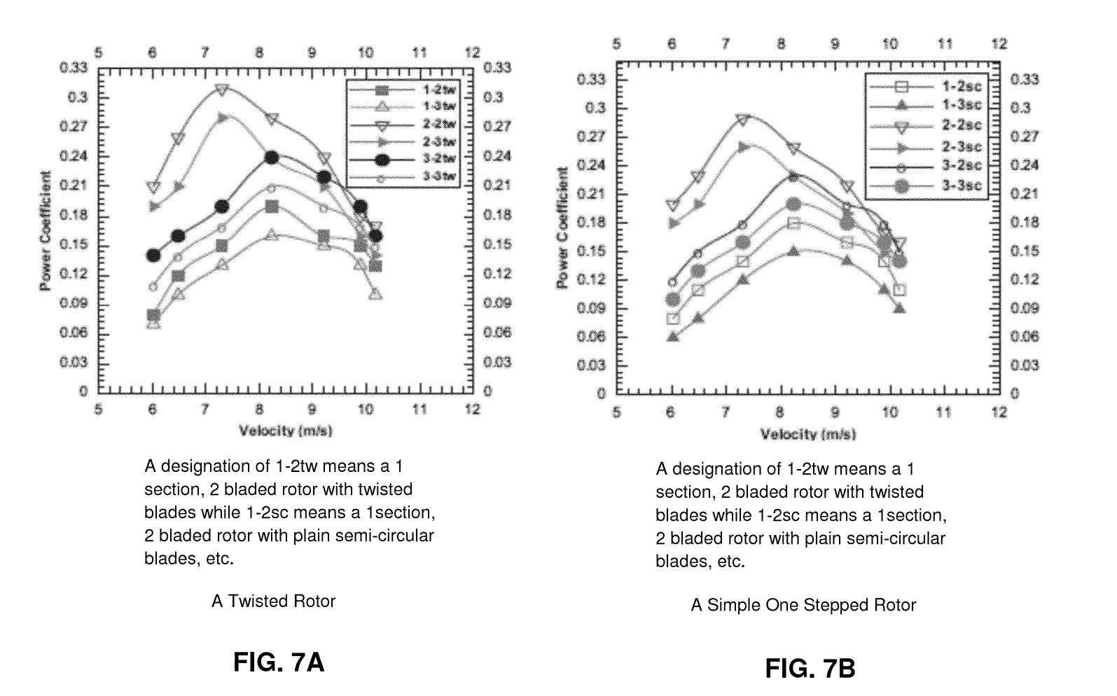

An alternate approach (to having more than two blades) is to “cut” the rotor into sections along the vertical axis of the rotor assembly, and to rotate each section relative to the one above (or below) it so as to produce a “two-blades-at-lots-of angles” design (FIG. 6A) that then produces a torque coefficient curve with multiple lobes, eventually closely simulating a smooth circular torque coefficient curve. The “trade off” in using a number of sections (or steps) in the Savonius rotor assembly is between the smoothness of the torque coefficient curve and the complexity of fabrication combined with increased rotor assembly weight. Most functional Savonius rotors assemblies have either 1 or 2 steps inasmuch as after this level of complexity, the additional structure required increases the rotor inertia to the point that it costs more in efficiency than it gains. A more sophisticated solution is to twist the rotor assembly into a helix shape—effectively making an infinite number of steps (FIG. 6B). While an elegant solution, such a helical configuration is significantly more difficult to form than a simple stepped device, and the performance increase of 2-3% Cp over the simpler approach generally does not justify this added complexity (FIGS. 7A and 7B).

### Inflatable Savonius Rotor Assembly

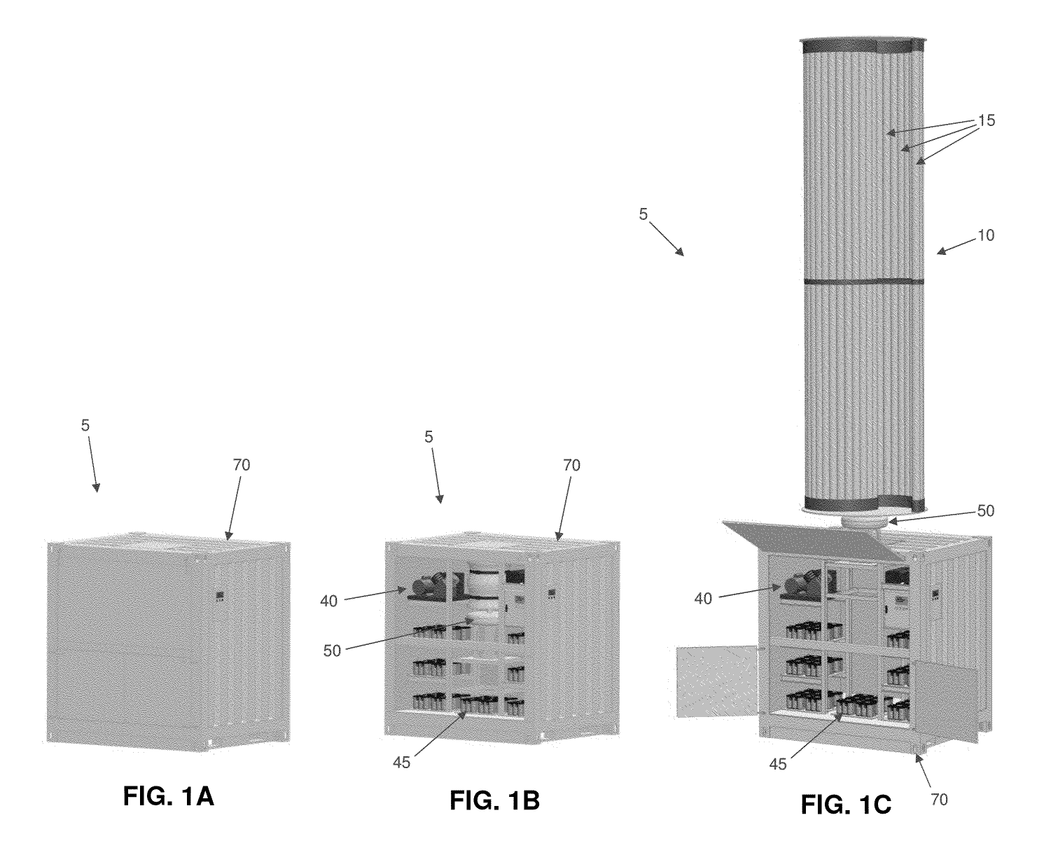

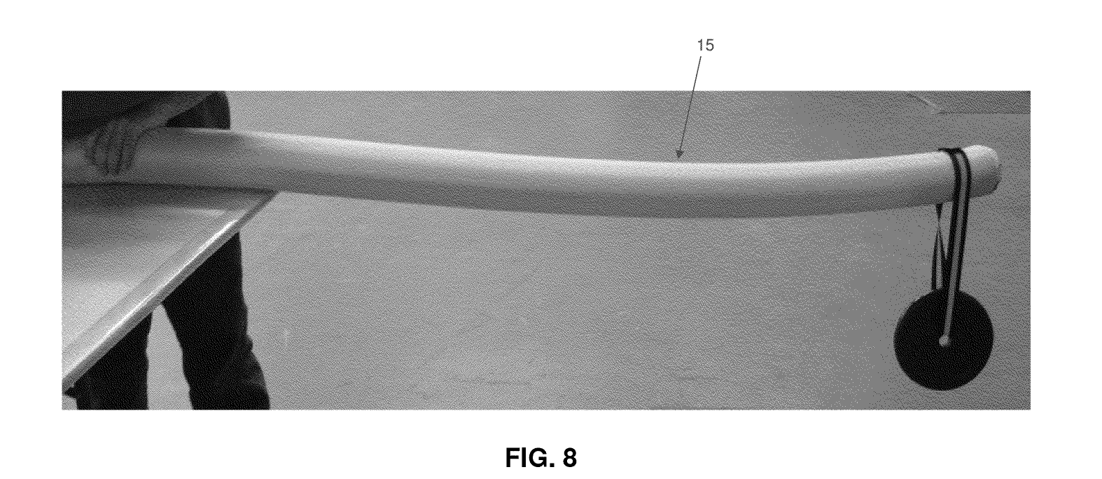

In accordance with the present invention, and looking now at FIGS. 1A, 1B and 1C, there is provided a novel Savonius wind turbine system 5 comprising an inflatable rotor assembly 10 constructed from a plurality of “air beams” 15 which are assembled together so as to collectively form the inflatable rotor assembly 10. As discussed in further detail below, air beams 15 are high-pressure inflated structures consisting of a gas-impermeable liner and a custom-woven, braided or knitted tensile sleeve that overlies the gas-impermeable liner and provides strength and, under the pressure of inflation, stiffness to the air beam. As also discussed in further detail below, a plurality of air beams 15 are assembled together so as to collectively form the inflatable rotor assembly 10. Air beams 15 are used to form the inflatable rotor assembly 10 inasmuch as air beams offer a number of desirable attributes:
air beams are structural inflatables (FIG. 8), e.g., a 4 inch diameter air beam inflated to 40 psi supports a 10 pound point load at 5 feet;
unlike rigid structures, air beams are capable of being “rolled up”, flaked or compressed so as to provide a much smaller packaged size;
also unlike rigid structural materials, air beams are extremely resilient and can withstand loads above a yield threshold without being permanently deformed—air beams withstand excessive loads by flexing and then springing back into their original shape once the strain returns to normal;
air beams are lighter than rigid structural members;
air beam systems are quicker to deploy and dismantle than other temporary structures;
once inflated, air beams will remain at the same pressure for weeks and even years without requiring re-inflation;
air beams can be straight, circular and even elliptical in profile;
air beams are manufactured using a proprietary technique with “technical” fibers (e.g., Kevlar, Vectran, M5, polyester, etc.) that allows them to be inflated to very high pressures (e.g., the maximum pressure achieved to date is 900 psi in a 4 inch diameter air beam); and
being all-fabric, the air beam is substantially invisible to radar, generating no radar signature and creating no radar shadowing which could mask threats.

### Air Beams in General

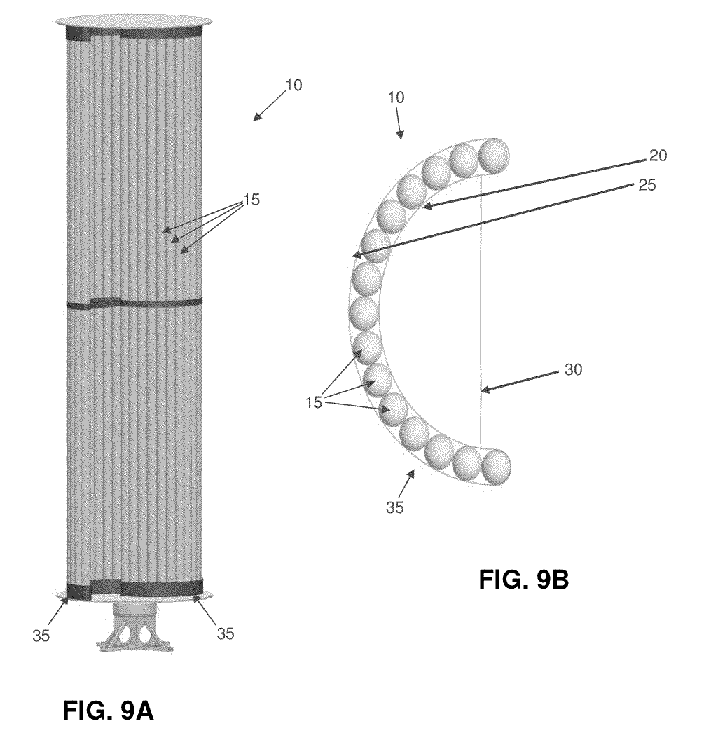

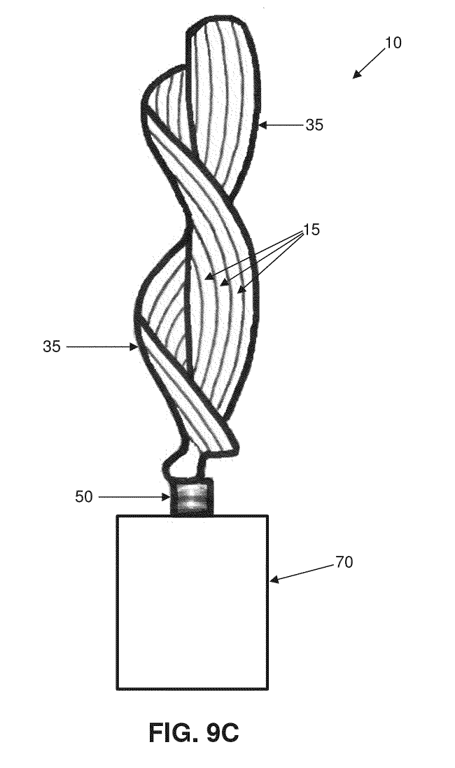

In accordance with the present invention, and looking now at FIGS. 1A, 1B, 1C, 9A and 9B, the inflatable rotor assembly 10 is formed out of a plurality of high pressure inflated tubes (i.e., air beams) 15 which are assembled together so as to collectively form the inflatable rotor assembly 10. More particularly, the high pressure inflated tubes preferably have a relatively small diameter (e.g., 4 inches), and are inflated to a relatively high pressure (e.g., 25-100 psi, or higher), whereby to render the high pressure inflated tubes substantially rigid during normal operation. Significantly, because the high pressure inflated tubes are inflated to a high pressure (e.g., 25-100 psi, or higher), the high pressure inflated tubes can be formed with relatively high length-to-width aspect ratios (e.g., 20:1 or more, and in any case generally more than 10:1) without negatively affecting the rigidity of the high pressure inflated tubes. This greatly simplifies construction of the inflatable rotor assembly.

In other words, with the present invention, the high pressure inflated tubes 15 effectively form substantially rigid “air beams” for assembling the inflatable rotor assembly 10. For the purposes of the present invention, the term “rigid” (or “substantially rigid”) is intended to mean having a structural integrity which provides operational performance similar to a rigid blade formed by conventional metal and/or composite sections.

The high pressure inflated tubes 15 are secured to one another, e.g., by textile strapping 20, 25, 30 (FIG. 9B), whereby to collectively form one or more substantially rigid blades 35 using the high pressure inflated tubes 15. Thus, in one preferred form of the invention, where the air beams 15 are disposed adjacent to one another so as to collectively form a blade 35, textile strapping 20 may be positioned on the front surface of the blade, and textile strapping 25 may be positioned on the rear surface of the blade. Cross-strapping 30 may also be provided. Additionally and/or alternatively, the high pressure inflated tubes 15 may be secured directly to one another, e.g., by bonding or gluing.

Thus, by forming the inflatable rotor assembly 10 out of a plurality of air beams 15, the inflatable rotor assembly 10 is provided with the stiffness needed for structural integrity and wind load capacity, while being extremely lightweight and easily collapsible.

The high pressure inflated tubes 15 are preferably formed out of an airtight woven, braided or knitted structure, in order to provide a structurally competent airtight casing able to resist the high pressure loads established within the inflatable tubes. By way of example but not limitation, the high pressure inflated tubes may be fabricated out of (i) an outer structural fabric, which is woven, knitted or braided from fibers (e.g., aramid fibers such as Kevlar or vectran or other structural fibers such as polyester) that will resist the high inflation pressure of the tube (e.g., 25-100 psi, or higher), and (ii) an inner gas-impermeable liner fabricated from a gas-impermeable plastic such as polyurethane.

The high pressure inflated tubes 15 may each be independently inflated, or groups of tubes may be inflated together, or all of the tubes in the inflatable rotor assembly may be inflated together. In general, it is preferred that each of the high pressure inflated tubes be independently inflated, simultaneously from a single fluid source, so as to ensure that the inflatable rotor assembly 10 inflates as a unit but, at the same time, the loss of inflation in any one tube does not affect the inflation of the other tubes.

### Inflatable Rotor Assembly with Air Beams Oriented Vertically

In one preferred form of the present invention, the inflatable rotor assembly 10 is constructed of a plurality of individual high-pressure (e.g., 50 psi) air beams 15 that are strapped together so as to form two semi-circular blades 35 (FIGS. 9A and 9B). By using different length straps 20, 25 on the inner and outer curves of the blades, respectively, a 60 inch long array of fifteen 4 inch diameter air beams can form a semicircular blade 35 that is approximately 36 inches in diameter (FIG. 9B). Two such blades 35 may be used to form a simple 1-section rotor such as is shown in FIG. 9A.

Alternatively, if desired, a plurality of vertically-oriented air beams 15 can be used to form a multi-stage inflatable rotor assembly, e.g., a multi-stage inflatable rotor assembly with a configuration analogous to the multi-stage rotor assembly shown in FIG. 6A.

### Inflatable Rotor Assembly with Air Beams Oriented Helically

If desired, a plurality of air beams 15 can be oriented in a helical fashion so as to form a helical inflatable rotor assembly, e.g., a helical inflatable rotor assembly with a configuration analogous to the helical rotor assembly shown in FIG. 6B. See, for example, FIG. 9C, which shows an inflatable rotor assembly 10 having its air beams 15 oriented in a helical fashion.

### Inflatable Rotor Assembly with Air Beams Oriented Horizontally

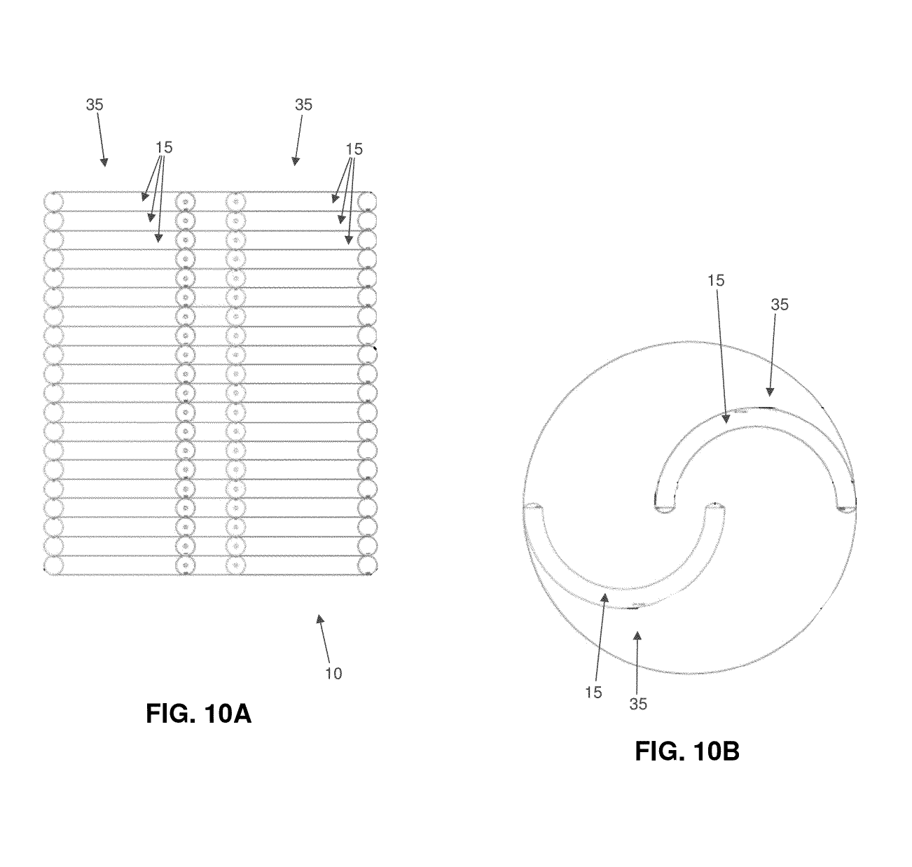

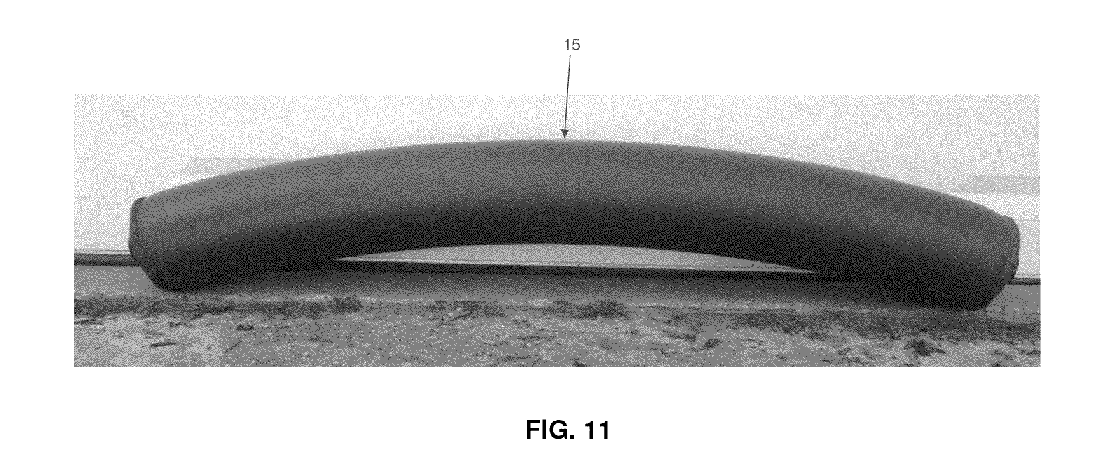

In an alternative configuration, a series of horizontal half-circle air beams 15 may be stacked one on top of another so as to form the inflatable rotor assembly 10 (FIGS. 10A and 10B). This alternative approach may provide a more stable configuration. Significantly, if desired, the individual horizontally-oriented air beams can be staggered (i.e., offset from one another with each successive air beam) so as to form a gradual helix (e.g., as is favored in some Savonius turbine designs) whereby to “smooth out” the torque curve of the stepped inflatable rotor assembly design as discussed above. In other words, the horizontally-oriented air beams can be used to form a helical inflatable rotor assembly with a configuration analogous to the helical rotor assembly shown in FIG. 6B (see, for example, FIG. 9C). A small sub-section of an appropriately-sized and shaped air beam is shown in FIG. 11.

### Air Compressor

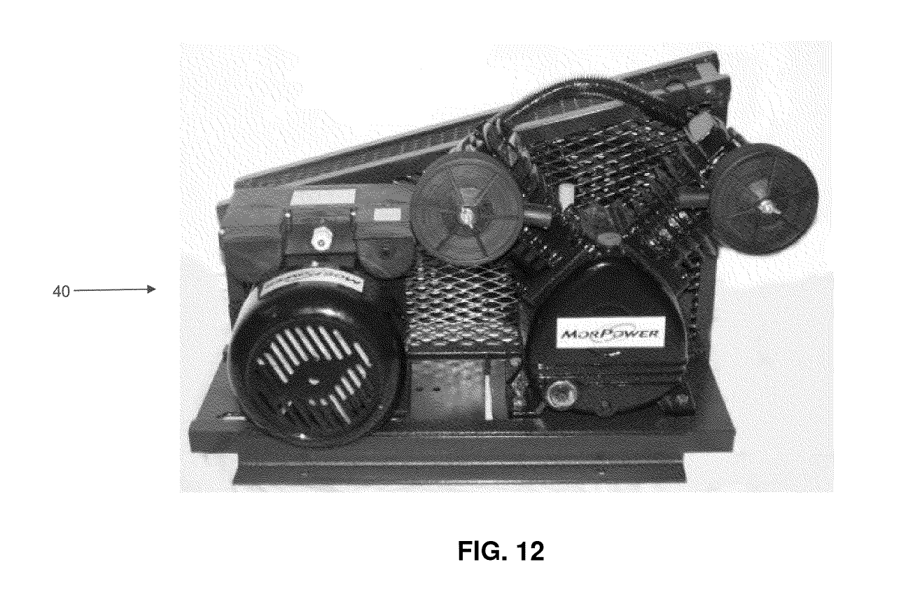

The inflatable rotor assembly 10 is preferably inflated by a dedicated compressor 40 included with the wind turbine system 5 (FIGS. 1B and 1C). A suitable air compressor 40 is shown in FIG. 12. This 3 horsepower, 120 volt compressor is preferably powered by the battery pack 45 (FIGS. 1B and 1C) included in the wind turbine system 5 (via an inverter, see below) and provides 8 cubic foot meters of air at 50 psi to inflate the inflatable rotor assembly 10 (e.g., 25 foot high by 6 foot diameter) to working pressure, standing vertical and functional in all but the strongest winds, in less than 5 minutes (and to maximum inflation pressure in about 8 minutes). The inflation system then monitors rotor pressure and, if it falls below optimum, the compressor 40 automatically re-starts.

### Generator

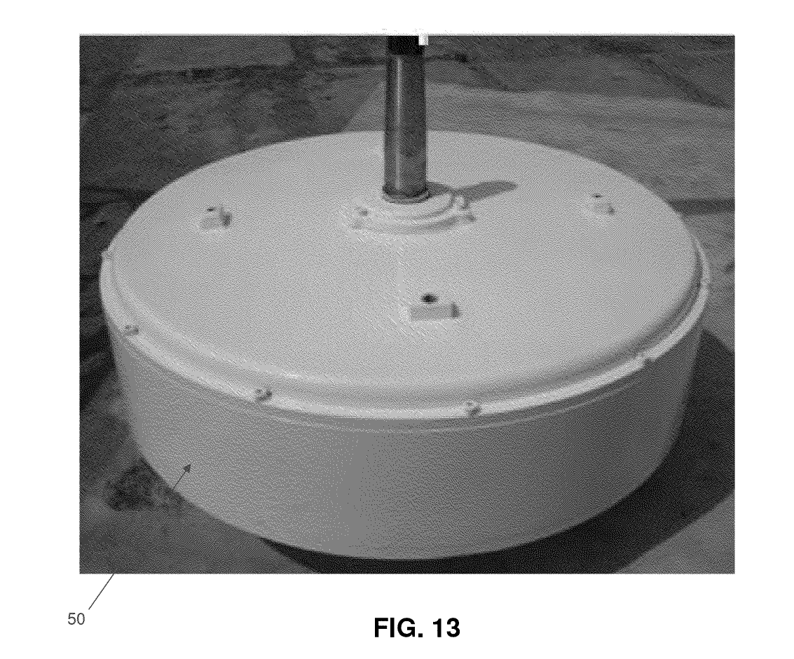

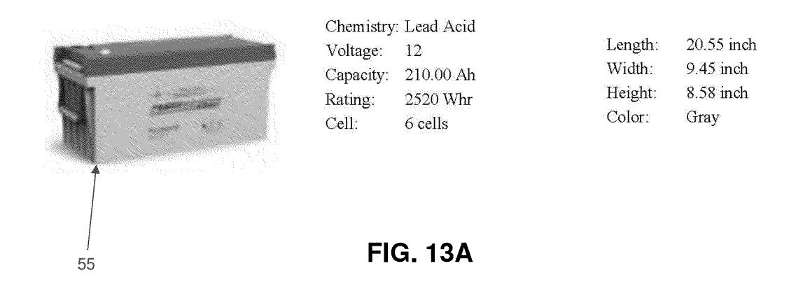

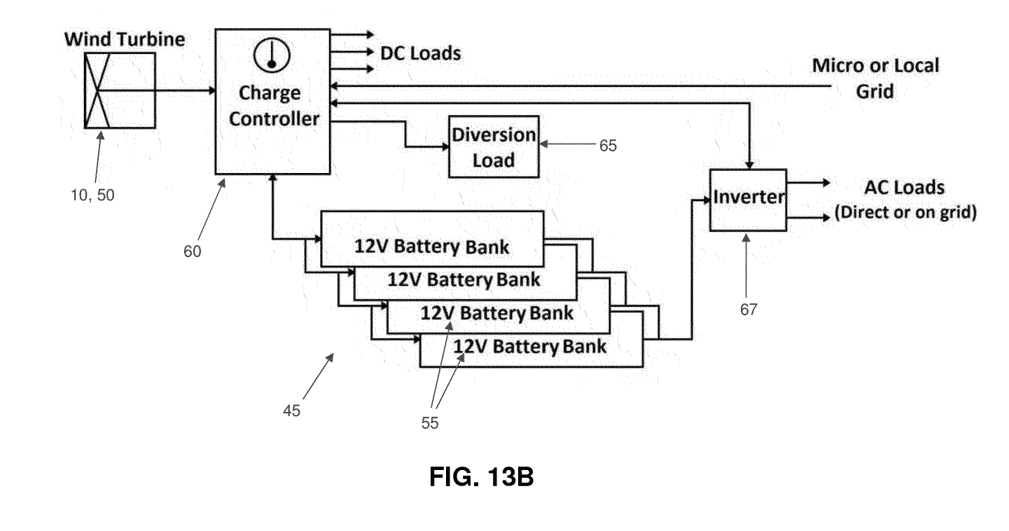

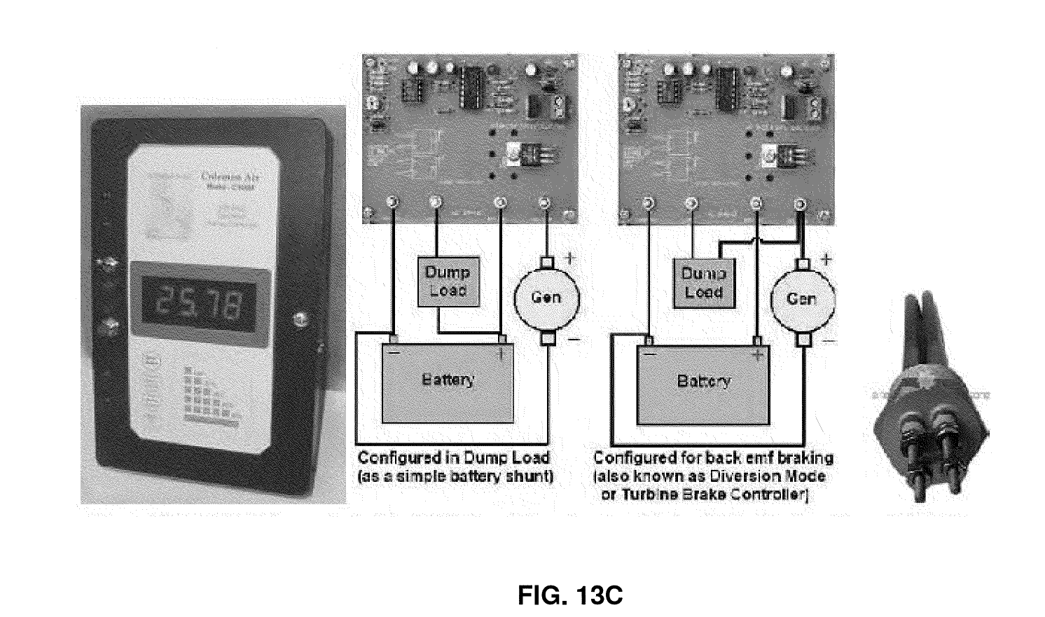

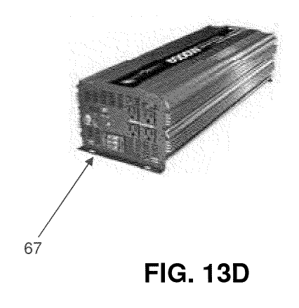

The novel Savonius wind turbine system 5 includes a generator 50 (FIGS. 1B, 1C and 13) for Converting the rotary motion of inflatable rotary assembly 10 into electrical power for storage in battery pack 45 and/or for offloading to a grid (or mini-grid). Most small wind turbines use permanent magnet (PM) generators which are typically direct-coupled to the rotor assembly (i.e., no gearbox is required). Direct-drive PM generators are characterized by low maintenance and high efficiency, and can be designed with very low starting torques (meaning low “cut-in” wind speeds), making them ideal for this application.

During start-up, when the rotor speed (ω) is very low, the turbine shaft power (Pt) is low (see Eq. 3 above). At start-up, the cogging torque of the PM generator must be low enough that the aerodynamic power of the rotor assembly can overcome the cogging torque of the PM generator. Cogging torque is the torque produced by the shaft when the rotor of a PM generator is rotated with respect to the stator at no load condition. Cogging torque is an inherent characteristic of PM generators and is caused by the geometry of the generator. Good generator designs such as the DVE Technologies product (see FIG. 13) reduce cogging torque via pole shifting, uneven distribution of stator slots and stator tooth notching. This translates to a very low cut-in speed (well below 10 mph) and an efficiency in excess of 95%. The PM generator is also synchronous (since the rotor windings have been replaced with the permanent magnets) which eliminates the excitation losses in the rotor, which otherwise typically represents 20 to 30 percent of the total generator losses. This leads to a considerably higher part load efficiency for the PM variant compared to asynchronous generators. This high efficiency and multi-poled layout of the PM generator leads to better utilization of the wind energy and enables gearless power transmission.

Some advantages of the DVE Technologies product shown in FIG. 13 are as follows:
5000 watt output;
start torque: 16.7 Newton meters;
rated Speed: 50 rpm; and
weight: 250 kg

### Battery-Based Power Storage

The novel Savonius wind turbine system 5 includes a battery pack 45 (FIGS. 1B and 1C) for storing the electrical power from generator 50, for powering air compressor 40, etc. Battery pack 45 preferably uses maintenance-free SLA (Sealed Lead Acid) batteries for energy ballast (i.e., short-term storage with high peaking capacity). AGM (Absorbed Glass Mat) or Gel Cells are both sealed, valve-regulated SLA batteries, allowing them to be used in any position. The difference between the AGM batteries and Gel Cell batteries lies in the way the electrolyte is immobilized. In the case of AGM batteries (the newer of the two technologies), the electrolyte is absorbed by the glass fiber separator which acts like a sponge. In the case of Gel Cell batteries, the liquid electrolyte turns into a gel immediately after the battery is filled. Gel Cell batteries use a different type of separator which is not absorbent. Due to their design, Gel Cell batteries do not offer the same power capacity as do AGM batteries of the same physical size. For example, where an AGM battery is 12 volt 100 Amp hours, a Gel Cell battery having the same size case would only be rated at 84 Amp hours. However, the Gel Cell battery excels in slow discharge rates and slightly higher operating temperatures. The internal design is otherwise similar.

The actual number of batteries included in the battery pack 45 of the Savonius wind turbine system 5 depends on several system specifications and characteristics, depending on:
the peak power required from the system;
the load power draw profile;
the required mission life for battery-only power in no-wind conditions; and
the allowable weight/volume for the battery pack.

These specifications allow for the selection of the specific battery most appropriate to the system needs—the major trade-offs include discharge rate and capacity. SLA-type batteries have their capacity rated depending on the amount of amps they can discharge over a certain period of time. General SLA batteries are usually rated at 20 hours, meaning their current supply over a period of 20 hours. If a battery is rated at 20 Amp hour capacity at 20 hours, it means that the battery can discharge 1 amp per hour over that 20 hour period. A high rate battery will typically be rated at 10 hours or less. So if a high rate battery is 20 Amp hour capacity at 10 hours, it would be able to discharge 2 amps per hour over a 10 hour period. Generally, a battery will have more effective capacity if it is discharged slowly and conversely, the battery will have less effective capacity if it is discharged quickly. For example, if a 20 Amp hour (10 hour) rated battery is discharged over a 20 hour period (20 hour), the effective capacity could be 23 Amp hours. If the same 20 Amp hour (20 hour) battery is discharged over a 5 hour period, then the effective capacity may be only 15 Amp hours, a loss of 25%. High rate batteries, however, are manufactured in a way to maximize quick discharge at the expense of deep cycling and cyclic life. They can discharge high amps at very short periods of time. For example, a 20 Amp hour (10 hour) high rate battery can discharge 70 Amps over a 5 minute period, while a general SLA battery may only be able to do just 45 Amps.

In general, the novel Savonius wind turbine system 5 incorporates as much SLA-based power storage as the allowable system weight provides for. At this time, assuming a maximum allowable tare weight in the Tricon container of 9,000 lbs for the system, with a very conservative 1,000 lb for the inflatable rotor assembly 10, compressor 40, generator 50 and power inverter and controller, etc., there remains up to 8,000 lbs for the battery pack 45. Assuming the use of a battery 55 similar to that shown in FIG. 13A, up to 55 batteries may be incorporated in the system for a power storage capacity of almost 140 kilowatt hours (or the equivalent of almost 2 full days of maximum wind turbine output for a 3,000 Watt system). Preferably the battery array 45 is subdivided into several individually-controllable sub-arrays, so if a number of individual batteries 55 become non-functional, the impact on the overall system can be minimized.

### System Power Management

The power flow of the novel Savonius wind turbine system 5 is preferably as shown in FIG. 13B. A charge controller or regulator 60 is vital for any wind turbine used to charge a battery bank. A typical wind turbine charge controller constantly monitors the battery voltage. If that voltage approaches a set maximum (the float voltage of 13.2 to 15.2 Volts for 12 Volt charging), then the controller 60 turns on a dump or diversion load (e.g., a shunt) 65 which dissipates excess power in order to prevent it from over-charging the batteries 55. When the battery voltage is measured to have fallen back below a set threshold (typically 0.2 to 0.5 Volt below the float voltage), the dump/diversion load 65 will be turned off and battery charging will commence again. The regulator/dump load relationship can be configured in one of two different ways (FIG. 13C)—either as a simple battery shunt dump load or in diversion mode. When configured as a battery shunt, the dump load is powered directly from the battery, thereby bringing down the battery's level of stored charge and preventing it from being overcharged. When configured in diversion mode, the dump load is powered only by the instantaneous power generated by the generator 50, i.e., the battery retains whatever charge it holds, but all power from the generator 50 is diverted to the dump load. This second configuration is generally preferred for the novel Savonius wind turbine system 5 for two reasons: first, it ensures that maximum system power is always available from the battery bank 45 for the “real” loads when the turbine/generator output is not being used for charging, and second, the diversion device continues to “load” the generator and so requires torque from the turbine effectively acting as a brake and preventing over-speeding of the turbine.

The most common type of diversion load is a low voltage electric immersion heater element for water heating (FIG. 13C). All the common charge control systems such as the Xantrex C40 or C60, Morningstar TS-45 or TS-60 or the Outback MX-60 are designed for load diversion. In the scenario where the novel Savonius wind turbine system 5 is part of a micro-grid or even a larger power grid within an expeditionary base or refugee relief camp, etc., the controller 60 will also allow the system to use the grid as the “diversion load” and for excess turbine power to be diverted into the grid as appropriate. The controller 60 will also constantly monitor the system power storage and supply status and as necessary can tap the grid for input power to either directly meet load requirements or to charge the battery packs 45 when its own rotor assembly and generator cannot do so.

The system can be configured as shown in FIG. 13B to provide DC and AC power. DC power can be provided at both 12 Volt and 24 Volt levels and be used for radios and other vehicle-mounted electronics, shelter lighting, etc., while the AC, provided through an inverter 67, powers “conventional” devices. The inverter 67 is preferably a COTS item used in many vehicle applications and is used to convert battery power DC into AC at whatever voltage is appropriate to the load—in the case of the system, typically 120 Volts. They are available in whatever capacity is most appropriate for the system, from 100 Watts up to many thousands of watts—FIG. 13D shows a 6,000 Watt inverter unit.

### Tricon Integration

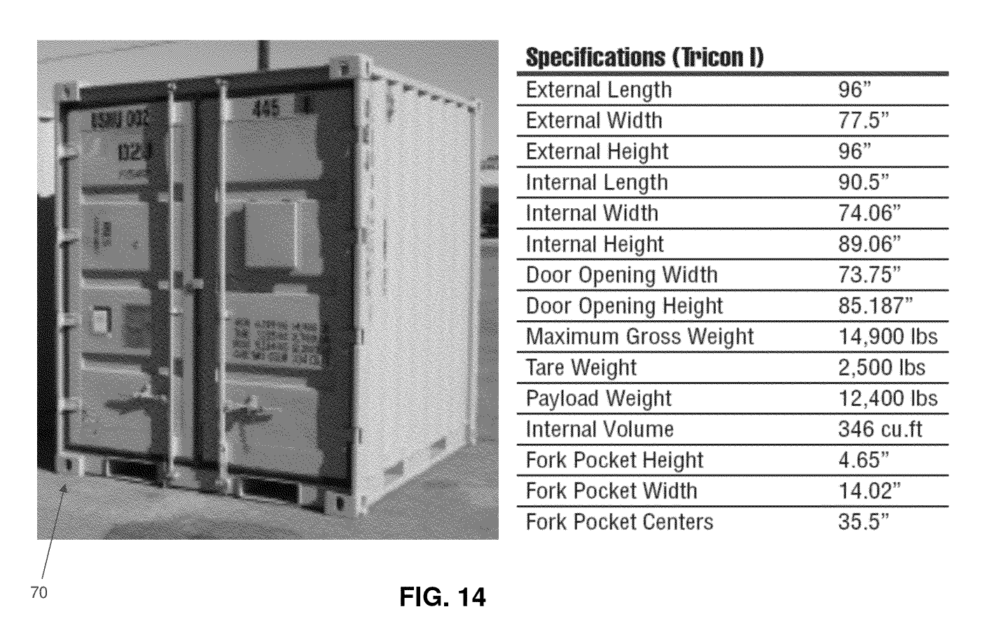

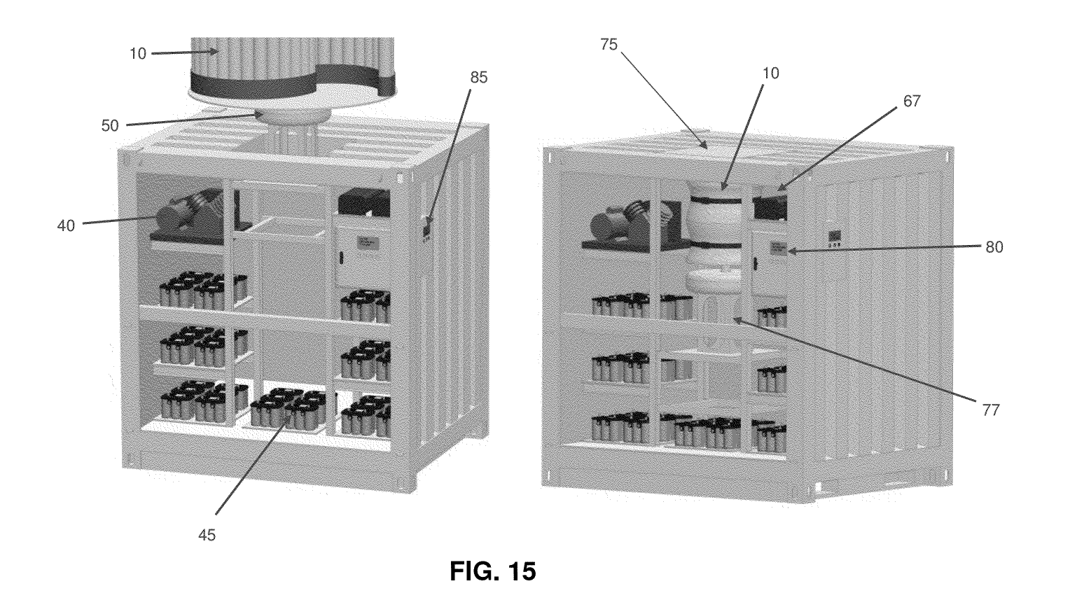

The system may be integrated into a Tricon container 70 (FIG. 14). These inter-modal shipping units are basically an empty box and the integration of the novel Savonius wind turbine system 5 into the Tricon container is largely just a “packaging exercise”. FIGS. 1A, 1B, 1C, and 15 show one conceptual layout. The inflatable rotor assembly 10 stores inside the Tricon container 70 in its uninflated state and, when it is to be deployed, it and the direct drive generator 50 are raised through a hatch 75 in the roof by a simple jack system 77 so that when inflated, the rotor blades clear the Tricon container. Control electronics 80 (e.g., charge controller 60, inverter 67, etc.) and inflation compressor 40 are housed high in the Tricon container 70 to free the lower volume for the heavy battery pack 45. The control electronics 80 are accessible from a panel 85 on the exterior face of the Tricon container 70.

### Non-Tricon Integration

As noted above, the novel Savonius wind turbine system 5 can be configured so that the inflatable rotor assembly 10 “pops up” out of a Tricon container 70 (i.e., ⅓ of a 20-ft ISO container). However, the inflatable rotor assembly 10 could also be freestanding, or part of a permanent installation, or installed in a box truck, or mounted on a trailer, or incorporated in any size ISO or non-ISO container, or installed in another structure.

### System Performance

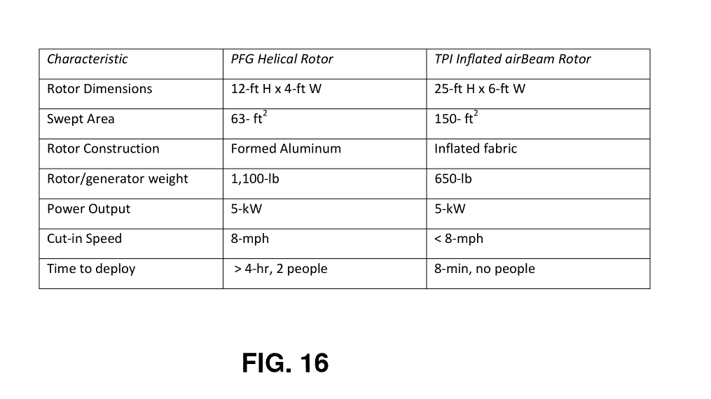

FIG. 16 shows a comparison of the operating parameters of the novel Savonius wind turbine system 10 vs. a similar, commercially-available wind turbine system. More particularly, FIG. 16 shows the operating parameters of the PFG Green Energy helical Savonius turbine, which uses a helical rotor formed from shaped aluminum sheets. The 63 foot² rotor drives a 5 kW, low speed, low start torque PM generator. The cut-in speed is just 8 mph. The novel Savonius wind turbine system 5 is twice as high as the PFG rotor and wider. It therefore offers twice the swept area and so, at a gross level, derives twice the power from the impinging wind. If the novel Savonius wind turbine system 10 uses the same generator as the PFG system, the necessary starting torque will be provided at much lower wind speeds. Additional benefits of the present invention are the obvious weight and packed volume savings, plus the huge difference in erection time and support required.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A wind turbine assembly comprising an inflatable rotor assembly.

2. A wind turbine assembly according to claim 1 wherein the inflatable rotor assembly comprises a shaft having at least two inflatable blades attached thereto.

3. A wind turbine assembly according to claim 2 wherein the shaft is oriented vertically.

4. A wind turbine assembly according to claim 2 wherein the inflatable blades comprise paddles.

5. A wind turbine assembly according to claim 2 wherein the inflatable blades each comprise a plurality of air beams.

6. A wind turbine assembly according to claim 5 wherein each of the air beams is oriented vertically.

7. A wind turbine assembly according to claim 6 wherein the air beams form a single stage.

8. A wind turbine assembly according to claim 6 wherein the air beams form a plurality of stages.

9. A wind turbine assembly according to claim 5 wherein each of the air beams extends helically.

10. A wind turbine assembly according to claim 2 wherein each of the air beams is oriented horizontally.

11. A wind turbine assembly according to claim 1 further comprising a container, and further wherein the inflatable rotor assembly is deployably housed within the container when the inflatable rotor assembly is in its uninflated state.

12. A method for producing power, the method comprising:
providing a wind turbine assembly comprising an inflatable rotor assembly;
inflating the inflatable rotor assembly;
allowing moving fluid to contact the inflatable rotor assembly, whereby to rotate the inflatable rotor assembly; and
harnessing the rotational motion of the rotor assembly so as to produce power.

13. A method according to claim 12 wherein the inflatable rotor assembly comprises a shaft having at least two inflatable blades attached thereto.

14. A method according to claim 13 wherein the shaft is oriented vertically.

15. A method according to claim 13 wherein the inflatable blades comprise paddles.

16. A method according to claim 13 wherein the inflatable blades each comprise a plurality of air beams.

17. A method according to claim 16 wherein each of the air beams is oriented vertically.

18. A method according to claim 17 wherein the air beams form a single stage.

19. A method according to claim 17 wherein the air beams form a plurality of stages.

20. A method according to claim 16 wherein each of the air beams extends helically.

21. A method according to claim 13 wherein each of the air beams is oriented horizontally.

22. A method according to claim 12 wherein the wind turbine assembly further comprises a container, and further wherein the inflatable rotor assembly is deployably housed within the container when the inflatable rotor assembly is in its uninflated state.
